(19) United States
(12) Patent Application Publication
(10) Pub. No.: US 2021/0325992 A1
(43) Pub. Date: Oct. 21, 2021

(54) TOUCH DETERMINATION METHOD AND TOUCH DEVICE

(71) Applicant: SHENZHEN ROYOLE TECHNOLOGIES CO., LTD., Shenzhen (CN)

(72) Inventor: Jianpeng Li, Shenzhen (CN)

(21) Appl. No.: 17/356,979

(22) Filed: Jun. 24, 2021

Related U.S. Application Data
(63) Continuation of application No. PCT/CN2018/123193, filed on Dec. 24, 2018.

(51) Int. Cl. G06F 3/041; G06F 3/044

(52) U.S. Cl. CPC G06F 3/0416; G06F 3/044

(57) ABSTRACT

A touch determination method and a touch device. The touch determination method is applied to a touch device having a non-uniform thickness, and including: obtaining a position coordinate range (xₐ, x_{b}) based on sensing signal data generated by a touch operation of a user on the touch panel; and selecting one coordinate xₘ from the position coordinate range (xₐ, x_{b}), and obtaining a touch center position coordinate through compensation based on the coordinate xₘ.

### CROSS-REFERENCE TO RELATED APPLICATION

This application is a continuation of International Disclosure No. PCT/CN2018/123193, filed on Dec. 24, 2018. The disclosures of the aforementioned disclosures are hereby incorporated by reference in their entireties.

### TECHNICAL FIELD

The present invention relates to the field of touch technologies, and in particular, to a touch determination method and a touch device.

### BACKGROUND

At present, increasing electronic devices are provided with touch screens to enhance performance of man-machine interaction. Existing touch screens are primarily planar in design, while a growing number of electronic devices will be designed primarily based on a curved surface in the future. However, a curved-surface touch screen usually has a non-uniform thickness. Therefore, detection of precise coordinates of a touch is affected. For example, on a planar touch screen with a uniform thickness in FIG. 1a, a position with a relatively concentrated sensing amount is a touch center position. On an arc-surface touch screen in FIG. 1b, because the thickness on the edges is small, a peak sensing amount shifts to the edges, causing a touch center position to shift, affecting touch detection precision.

### SUMMARY

To solve the above-mentioned problem, the embodiments of the present invention disclose a touch determination method and a touch device, so as to improve touch detection precision.

Disclosed is a touch determination method, applied to a touch panel having a non-uniform thickness, and including: obtaining a position coordinate range (xₐ, x_{b}) based on sensing signal data generated by a touch operation of a user on the touch panel; and selecting one coordinate xₘ from the position coordinate range (xₐ, x_{b}), and obtaining a touch center position coordinate through compensation based on the coordinate xₘ.

Disclosed is a touch device, including: a touch panel having a non-uniform thickness and a processor, where the touch panel is configured to generate sensing signal data based on a touch operation of a user, and the processor is configured to: obtain a position coordinate range (xₐ, x_{b}) based on the sensing signal data; and select one coordinate xₘ from the position coordinate range (xₐ, x_{b}), and obtain a touch center position coordinate through compensation based on the coordinate xₘ.

According to the touch determination method and the touch device provided in the present invention, one coordinate xₘ is selected from the sensed position coordinate range (xₐ, x_{b}), and the touch center position coordinate is obtained through compensation based on the coordinate xₘ, thereby improving touch detection precision.

### BRIEF DESCRIPTION OF DRAWINGS

To describe the technical solutions in the embodiments of the present invention more clearly, the following briefly describes the accompanying drawings required for the embodiments. Apparently, the accompanying drawings in the following description show merely some embodiments of the present invention, and a person of ordinary skill in the art may still derive other drawings from these accompanying drawings without creative efforts.

FIG. 1a is a schematic diagram illustrating a sensing amount distribution in a planar touch screen upon a touch operation of a user according to the prior art;

FIG. 1b is a schematic diagram illustrating a sensing amount distribution in an arc-surface touch screen upon a touch operation of a user according to the prior art;

FIG. 2 is a structural block diagram illustrating a touch device according to an implementation of the present invention;

FIG. 3 is a schematic cross-sectional view illustrating a touch panel according to an implementation of the present invention;

FIG. 4 is a schematic enlarged view illustrating a local area IV of the touch panel shown in FIG. 3; and

FIG. 5 is a flowchart illustrating a touch determination method according to an implementation of the present invention.

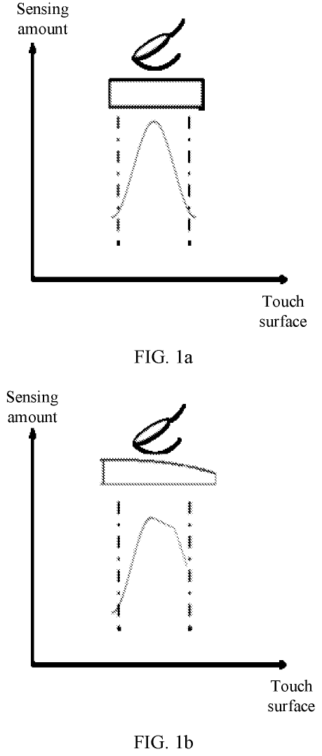

### DESCRIPTION OF EMBODIMENTS

The following clearly and completely describes the technical solutions in the embodiments of the present invention with reference to the accompanying drawings in the embodiments of the present invention. Apparently, the described embodiments are merely some rather than all of the embodiments of the present invention. All other embodiments obtained by a person of ordinary skill in the art based on the embodiments of the present invention without creative efforts shall fall within the protection scope of the present invention.

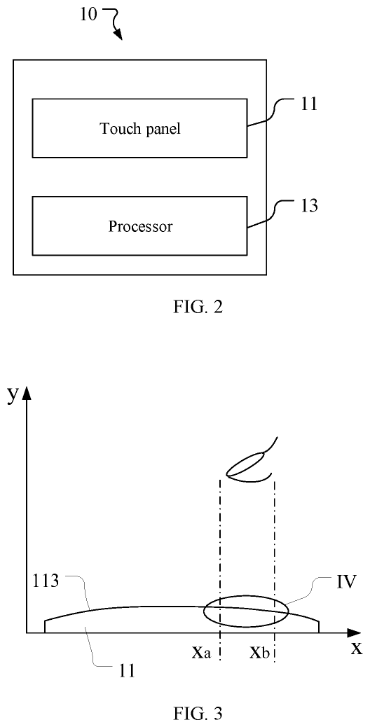

FIG. 2 is a structural block diagram illustrating a touch device according to an implementation of the present invention. A touch device 10 includes a touch panel 11 having a non-uniform thickness and a processor 13. The touch panel 11 is configured to generate sensing signal data based on a touch operation of a user. The processor 13 is configured to obtain a position coordinate range (xₐ, x_{b}), to be specific, a coordinate range of the touch operation on the X-axis, based on the sensing signal data; and select one coordinate xₘ from the position coordinate range (xₐ, x_{b}), and obtain a touch center position coordinate through compensation based on the coordinate xₘ, where the touch center position coordinate falls within the position coordinate range (xₐ, x_{b}).

The touch center position coordinate is obtained through compensation based on the coordinate xₘ selected from the position coordinate range (xₐ, x_{b}), thereby improving touch detection precision of the touch device 10.

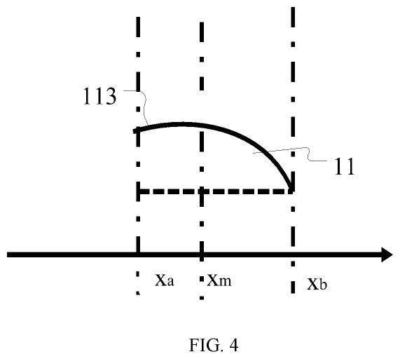

In the implementation, referring to FIG. 3 and FIG. 4, the touch panel 11 is a capacitive curved-surface touch panel. A thickness y corresponding to the touch panel 11 at any position coordinate x within the position coordinate range (xₐ, x_{b}) and the coordinate x meet a curve formula. The position coordinate range (xₐ, x_{b}) is an x coordinate range that extends along a surface of the touch panel 11.

In the implementation, a touch surface 113 of the touch panel 11 is an arc surface, and a cross section of the touch panel 11 is substantially arc-shaped. The curve formula is a sine function formula, and the sine function formula is presented as y=Asinωx, where A and ω are constants.

It can be understood that, the curve formula is not limited to a sine function, and may alternatively be another curve formula, for example, a cosine function.

It can be understood that, the touch surface 113 may not be an arc surface, and may be another curved-surface structure or a flat surface, and the touch panel 11 has a non-uniform thickness within the position coordinate range (xₐ, x_{b}).

Specifically, when the user touches the touch panel 11, a capacitance at a corresponding position on the touch panel 11 changes, and the sensing signal data is generated. The processor 13 obtains the position coordinate range (xₐ, x_{b}) based on the sensing signal data. Because the thickness y corresponding to the touch panel 11 at any position coordinate x within the position coordinate range (xₐ, x_{b}) and the coordinate x meet the sine function formula, the processor 13 obtains an actual thickness yₐ of the touch panel 11 at a position coordinate xₐ and an actual thickness y_{b} of the touch panel 11 at a position coordinate x_{b} by calculation based on y=Asinωx.

The processor 13 randomly selects one coordinate xₘ from the position coordinate range (xₐ, x_{b}). The processor 13 obtains an actual thickness yₘ of the touch panel 11 at the position corresponding to the coordinate xₘ and determines the compensation coefficient based on the actual thickness yin, including: converting an actual thickness yₘ at any position coordinate xₘ within the position coordinate range (xₐ, x_{b}) into a uniform thickness h, and establishing a touch panel model that has the uniform thickness h within the position coordinate range (xₐ, x_{b}); and determining the compensation coefficient based on the actual thickness yₘ and the uniform thickness h. In the implementation, the uniform thickness h is the actual thickness y_{b} of the touch panel 11 at the position coordinate x_{b}.

It can be understood that, the uniform thickness h is not limited to the actual thickness y_{b} of the touch panel 11 at the position coordinate x_{b}, and may be set to another value, for example, h is a mean value of yₐ and y_{b}.

It can be understood that, the touch panel model is not limited to having the uniform thickness h within the position coordinate range (xₐ, x_{b}), and the touch panel model corresponds to the same thickness at any coordinate x.

Further, a capacitance corresponding to the touch panel 11 at the coordinate xₘ is

$${C}_{m} = \frac{ɛ S}{{y}_{m}} ,$$

ε is a dielectric constant, and S is a relative electrode area of the touch panel 11 at a position corresponding to the coordinate xₘ.

The actual thickness yₘ at any coordinate xₘ within the position coordinate range (xₐ, x_{b}) is converted into the uniform thickness h. If the capacitance corresponding to the touch panel 11 at the coordinate xₘ is

$${C}_{m} = \frac{ɛ S}{{y}_{m}} ,$$

a capacitance corresponding to the touch panel model at the coordinate xₘ is a compensated capacitance

$${Cm}^{′} = \frac{ɛ S}{h} .$$

$${Cm}^{′} = \frac{{y}_{m}}{h} {C}_{m}$$

is obtained based on

$$\frac{{Cm}^{′}}{Cm} ,$$

where

$$\frac{{y}_{m}}{h}$$

is a compensation coefficient.

In the implementation, the actual thickness y corresponding to the touch panel 11 at any position coordinate x within the position coordinate range (xₐ, x_{b}) meets a curve formula: y=Asinωx, that is, y_{b}=Asinωx_{b} and yₘ=Asinωxₘ. The uniform thickness h is the actual thickness y_{b} corresponding to the touch panel 11 at the coordinate x_{b}, and the compensation coefficient is

$$\frac{{y}_{m}}{h} = \frac{{y}_{m}}{{y}_{b}} = \frac{{sin ω x}_{m}}{sin ω {x}_{b}} .$$

The processor 13 obtains compensated sensing signal data through compensation based on the compensation coefficient.

Sensing signal data D at the same position coordinate is directly proportional to a capacitance C. It is assumed that sensing signal data of the touch panel 11 at the coordinate xₘ is Dₘ, and Dₘ is directly proportional to Cₘ. The compensated sensing signal data is Dₘ′. Similarly, Dₘ′ is directly proportional to a compensated capacitance Cₘ′, and

$${{D}_{m}}^{′} = {D}_{m} \times \frac{{y}_{m}}{h} .$$

The processor 13 determines the touch center position coordinate by using the compensated sensing signal data. Further, the processor 13 determines a virtual touch position of the touch panel model based on the compensated sensing signal data, and the virtual touch position is the touch center position coordinate. In the implementation, the processor 13 determines the virtual touch position of the touch panel model by using a preset algorithm (for example, the PIXCIR algorithm or a centroid computation method) based on the compensated sensing signal data. It can be understood that, the preset algorithm may alternatively be implemented by selecting another algorithm.

In other words, it is equivalent to that the touch panel 11 having the non-uniform thickness within the position coordinate range (xₐ, x_{b}) is regarded as the touch panel model that has the uniform thickness h within the position coordinate range (xₐ, x_{b}), and the touch center position coordinate on the touch panel 11 is determined by determining the virtual touch position of the touch panel model.

It can be understood that, the processor 13 may calculate the touch center position coordinate by multiplying the selected coordinate xₘ with the compensation coefficient

$$\frac{{y}_{m}}{h} .$$

The coordinate xₘ may not be randomly selected, and may be obtained by using a preset algorithm such as

$${x}_{m} = \frac{xa + xb}{2} ,$$

or may be another value.

According to the touch device 10 provided in the present invention, the touch panel having the non-uniform thickness within the position coordinate range (xₐ, x_{b}) is converted into the touch panel model that has the uniform thickness h within the position coordinate range (xₐ, x_{b}) for compensation to determine the compensation coefficient and further obtain the touch center position coordinate, thereby improving the touch detection precision.

It can be understood that, the touch panel 11 is not limited to a capacitive touch panel, and the touch panel 11 may alternatively be another type of touch panel, for example, a resistive touch panel.

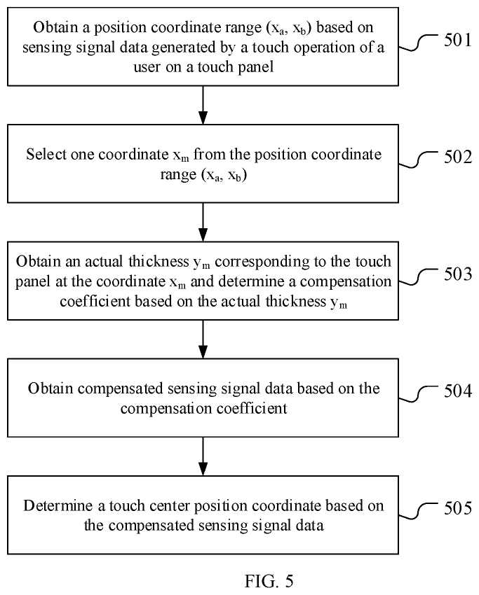

Referring to FIG. 5, the present invention further provides a touch determination method, applied to a touch panel having a non-uniform thickness, and including the following steps:

Step 501. Obtain a position coordinate range (xₐ, x_{b}) based on sensing signal data generated by a touch operation of a user on the touch panel. In the implementation, the touch panel is a capacitive curved-surface touch panel.

Step 502. Select one coordinate xₘ from the position coordinate range (xₐ, x_{b}).

Step 503. Obtain an actual thickness yₘ corresponding to the touch panel at the coordinate xₘ and determine a compensation coefficient based on the actual thickness yₘ.

The obtaining an actual thickness yₘ corresponding to the touch panel at the coordinate xₘ and determining a compensation coefficient based on the actual thickness yₘ includes: converting an actual thickness yₘ at any coordinate xₘ within the position coordinate range (xₐ, x_{b}) into a uniform thickness h, and establishing a touch panel model that has the uniform thickness h within the position coordinate range (xₐ, x_{b}); and determining that the compensation coefficient is

$$\frac{{y}_{m}}{h}$$

based on the actual thickness yₘ and the uniform thickness h.

In the implementation, a thickness y corresponding to the touch panel at any position coordinate x within the position coordinate range (xₐ, x_{b}) and the coordinate x meet a curve formula. In the implementation, the curve formula is a sine function formula, and the sine function formula is represented as y=Asinωx, where A and ω are constants. The uniform thickness h is an actual thickness y_{b} of the touch panel at a position coordinate x_{b}.

If a capacitance corresponding to the touch panel at the coordinate xₘ is

$${C}_{m} = \frac{ɛ S}{{y}_{m}} ,$$

a capacitance corresponding to the touch panel model at the coordinate xₘ is a compensated capacitance

$${Cm}^{′} = \frac{ɛ S}{{y}_{m}} .$$

$${Cm}^{′} = \frac{{y}_{m}}{h} {C}_{m}$$

is obtained based on

$$\frac{{Cm}^{′}}{Cm} ,$$

where

$$\frac{{y}_{m}}{h}$$

is the compensation coefficient. In the implementation, the thickness y corresponding to the touch panel at any position coordinate x within the position coordinate range (xₐ, x_{b}) meets a curve formula: y=Asinωx, that is, y_{b}=Asinωx_{b} and yₘ=Asinωxₘ The uniform thickness h is the actual thickness y_{b} corresponding to the touch panel at the coordinate x_{b}, and the compensation coefficient is

$$\frac{{y}_{m}}{h} = \frac{{y}_{m}}{{y}_{b}} = \frac{{sin ω x}_{m}}{sin ω {x}_{b}} .$$

It can be understood that, the uniform thickness h is not limited to the actual thickness y_{b} of the touch panel at the position coordinate x_{b}, and the uniform thickness h may be set to another value, for example, h is a mean value of yₐ and y_{b}.

It can be understood that, the touch panel model is not limited to having the uniform thickness h within the position coordinate range (xₐ, x_{b}), and the touch panel model corresponds to the same thickness at any coordinate x.

Step 504. Obtain compensated sensing signal data based on the compensation coefficient.

Sensing signal data D at the same position coordinate is directly proportional to a capacitance C. For example, sensing signal data Dₘ corresponding to the touch panel at the coordinate xₘ is directly proportional to a capacitance Cₘ. It is assumed that sensing signal data of the touch panel at the coordinate xₘ is Dₘ, and the compensated sensing signal data is Dₘ′. Similarly, Dₘ′ is directly proportional to

$${{D}_{m}}^{′} = {D}_{m} \times \frac{{y}_{m}}{h} .$$

a compensated capacitance Cₘ′, and

Step 505. Determine a touch center position coordinate based on the compensated sensing signal data. In the implementation, a virtual touch position of the touch panel model is determined based on the compensated sensing signal data, and the virtual touch position is determined as the touch center position coordinate.

In the implementation, the virtual touch position of the touch panel model is determined based on the compensated sensing signal data by using a preset algorithm. For example, the virtual touch position of the touch panel model is determined based on the compensated sensing signal data by using a preset algorithm (such as, the PIXCIR algorithm or a centroid computation method). It can be understood that, the preset algorithm may alternatively be implemented by selecting another algorithm.

In an implementation, a touch determination method is provided, and is applied to a touch panel having a non-uniform thickness. The method includes: obtaining a position coordinate range (xₐ, x_{b}) based on sensing signal data generated by a touch operation of a user on the touch panel; and selecting one coordinate xₘ from the position coordinate range (xₐ, x_{b}), and obtaining a touch center position coordinate through compensation based on the coordinate xₘ.

Further, the selecting one coordinate xₘ from the position coordinate range (xₐ, x_{b}), and obtaining a touch center position coordinate through compensation based on the coordinate xₘ includes: randomly selecting one coordinate xₘ from the position coordinate range (xₐ, x_{b}); obtaining an actual thickness yₘ corresponding to the touch panel at the coordinate xₘ and determining a compensation coefficient based on the actual thickness yₘ; obtaining compensated sensing signal data based on the compensation coefficient; and determining the touch center position coordinate based on the compensated sensing signal data.

Further, the obtaining an actual thickness yₘ corresponding to the touch panel at the coordinate xₘ and determining a compensation coefficient based on the actual thickness yₘ includes: converting an actual thickness yₘ at any position coordinate xₘ within the position coordinate range (xₐ, x_{b}) into a uniform thickness h, and establishing a touch panel model that has a uniform thickness h within the position coordinate range (xₐ, x_{b}); and determining that the compensation coefficient is

$$\frac{{y}_{m}}{h}$$

based on the actual thickness yₘ and the uniform thickness h.

Further, the obtaining an actual thickness yₘ corresponding to the touch panel at the coordinate xₘ and determining a compensation coefficient based on the actual thickness yₘ further includes: establishing a touch panel model that has a uniform thickness h within the position coordinate range (xₐ, x_{b}). The determining the touch center position coordinate based on the compensated sensing signal data includes: determining a virtual touch position of the touch panel model based on the compensated sensing signal data, where the virtual touch position is the touch center position coordinate.

Further, a thickness y corresponding to the touch panel at any position coordinate x within the position coordinate range (xₐ, x_{b}) and the coordinate x meet a curve formula.

Further, the curve formula is a sine function formula.

Further, the uniform thickness h is an actual thickness y_{b} of the touch panel at a position coordinate x_{b}.

Further, the position coordinate range (xₐ, x_{b}) is an x coordinate range that extends along a surface of the touch panel.

It can be understood that, the touch panel is not limited to a capacitive touch panel, and may be another type of touch panel, such as a resistive touch panel.

The foregoing descriptions are preferred embodiments of the present invention. It should be noted that a person of ordinary skill in the art may make several improvements or polishing without departing from the principle of the present invention and the improvements or polishing shall fall within the protection scope of the present invention.

What is claimed is:

1. A touch determination method, applied to a touch panel having a non-uniform thickness, wherein the method comprises:
obtaining a position coordinate range (xₐ, x_{b}) based on sensing signal data generated by a touch operation of a user on the touch panel; and
selecting one coordinate xₘ from the position coordinate range (xₐ, x_{b}), and obtaining a touch center position coordinate through compensation based on the coordinate xₘ.

2. The touch determination method according to claim 1, wherein the selecting one coordinate xₘ from the position coordinate range (xₐ, x_{b}), and obtaining a touch center position coordinate through compensation based on the coordinate xₘ comprises:
randomly selecting one coordinate xₘ from the position coordinate range (xₐ, x_{b});
obtaining an actual thickness yₘ corresponding to the touch panel at the coordinate xₘ and determining a compensation coefficient based on the actual thickness yₘ;
obtaining compensated sensing signal data based on the compensation coefficient; and
determining the touch center position coordinate based on the compensated sensing signal data.

3. The touch determination method according to claim 2, wherein the obtaining an actual thickness yₘ corresponding to the touch panel at the coordinate xₘ and determining a compensation coefficient based on the actual thickness yₘ comprises: converting an actual thickness yₘ at any position coordinate xₘ within the position coordinate range (xₐ, x_{b}) into a uniform thickness h; and determining that the compensation coefficient is
$$\frac{{y}_{m}}{h}$$
based on the actual thickness yₘ and the uniform thickness h.

4. The touch determination method according to claim 3, wherein the obtaining an actual thickness yₘ corresponding to the touch panel at the coordinate xₘ and determining a compensation coefficient based on the actual thickness yₘ further comprises: establishing a touch panel model that has the uniform thickness h within the position coordinate range (xₐ, x_{b}); and
the determining the touch center position coordinate based on the compensated sensing signal data comprises: determining a virtual touch position of the touch panel model based on the compensated sensing signal data, wherein the virtual touch position is the touch center position coordinate.

5. The touch determination method according to claim 3, wherein the uniform thickness h is an actual thickness y_{b} corresponding to the touch panel at a coordinate x_{b}.

6. The touch determination method according to claim 2, wherein a thickness y corresponding to the touch panel at any position coordinate x within the position coordinate range (xₐ, x_{b}) and the coordinate x meet a curve formula.

7. The touch determination method according to claim 6, wherein the curve formula is a sine function formula.

8. The touch determination method according to claim 1, wherein the position coordinate range (xₐ, x_{b}) is an x coordinate range of the touch operation that extends along a surface of the touch panel.

9. A touch device, comprising a touch panel having a non-uniform thickness and a processor, wherein the touch panel is configured to generate sensing signal data based on a touch operation of a user, and the processor is configured to: obtain a position coordinate range (xₐ, x_{b}) based on the sensing signal data; and select one coordinate xₘ from the position coordinate range (xₐ, x_{b}), and obtain a touch center position coordinate through compensation based on the coordinate xₘ.

10. The touch device according to claim 9, wherein the processor selects one coordinate xₘ from the position coordinate range (xₐ, x_{b}), and obtains the touch center position coordinate through compensation based on the coordinate xₘ, comprising:
randomly selecting one coordinate xₘ from the position coordinate range (xₐ, x_{b});
obtaining an actual thickness yₘ corresponding to the touch panel at the coordinate xₘ and determining a compensation coefficient based on the actual thickness yₘ;
obtaining compensated sensing signal data based on the compensation coefficient; and
determining the touch center position coordinate based on the compensated sensing signal data.

11. The touch device according to claim 10, wherein the processor obtains the actual thickness yₘ corresponding to the touch panel at the coordinate xₘ and determines the compensation coefficient based on the actual thickness yₘ, comprising: the processor converts a thickness at any position coordinate xₘ within the position coordinate range (xₐ, x_{b}) into a uniform thickness h; and determines that the compensation coefficient is
$$\frac{{y}_{m}}{h}$$
based on the actual thickness yₘ and the uniform thickness h.

12. The touch device according to claim 11, wherein the processor obtains the actual thickness yₘ corresponding to the touch panel at the coordinate xₘ and determines the compensation coefficient based on the actual thickness yₘ, further comprising: establishing a touch panel model that has the uniform thickness h within the position coordinate range (xₐ, x_{b}); and
the processor determines the touch center position coordinate based on the compensated sensing signal data, comprising: determining a virtual touch position of the touch panel model based on the compensated sensing signal data, wherein the virtual touch position is the touch center position coordinate.

13. The touch device according to claim 12, wherein the uniform thickness h is an actual thickness y_{b} corresponding to the touch panel at a coordinate x_{b}.

14. The touch device according to claim 10, wherein a thickness y corresponding to the touch panel at any position coordinate x within the position coordinate range (xₐ, x_{b}) and the coordinate x meet a curve formula.

15. The touch device according to claim 14, wherein the curve formula is a sine function formula.

16. The touch device according to claim 9, wherein the touch panel comprises a touch surface, and the touch surface is an arc surface.

17. The touch device according to claim 9, wherein the position coordinate range (xₐ, x_{b}) is an x coordinate range of the touch operation that extends along a surface of the touch panel.
